(19) United States
(12) Patent Application Publication
(10) Pub. No.: US 2013/0311310 A1
(43) Pub. Date: Nov. 21, 2013

(54) RESTAURANT COMMUNICATION SYSTEM AND METHOD UTILIZING DIGITAL MENUS

(71) Applicant: Gene Zell, Brooklyn, NY (US)

(72) Inventor: Gene Zell, Brooklyn, NY (US)

(21) Appl. No.: 13/471,717

(22) Filed: May 15, 2012

(51) Int. Cl. G06Q 50/12; G06Q 30/04; G06Q 20/20; G06Q 30/00

(52) U.S. Cl. 705/15

(57) ABSTRACT

A restaurant communication system including a first and second mobile devices, located in a restaurant, a server and a plurality of receiving devices. Receiving devices are located at the restaurant at locations where particular dishes are prepared. The server is positioned at a location remote to the restaurant and is wirelessly connectable to the first mobile device, the second mobile device and the receiving devices. The server has a database storing a menu with a plurality of dishes, each dish being associated with a dish image, a dish description and a location at the restaurant where this dish is prepared. An application of the first mobile device causes the dishes with images and descriptions to appear at the display, and also causes an order request to be sent to the second mobile device and to the appropriate receiving devices via the server when the user places an order.

### FIELD OF THE INVENTION

This invention relates to a system and method for creating interactive digital restaurant menus which are then accessed and used via a mobile device.

### BACKGROUND OF THE INVENTION

Modern restaurants include complex systems for buying, storing, preparing and selling food. The well-being of a restaurant depends on its management information systems, which coordinate everything from scheduling personnel to customer service. Every restaurant needs a strategy for taking orders, delivering information to the kitchen and charging customers for their food. These systems can be as simple as handwritten notes or as complicated as computer systems that send orders to the kitchen and tally sales for each server. Simple systems are less prone to technical difficulties, but they cannot process information as efficiently as smoothly functioning computer systems.

Restaurants depend on communicating information between different divisions, such as servers relaying orders to kitchen staff and kitchen staff letting servers know that their orders are ready. Most restaurants operate inefficiently because their wait-staff has to spend much of their time gathering and distributing information. For example, waiters repeatedly visit tables to ask if the customers have any requests, if they are ready to order, ready for their check, to advise them how their order is progressing, etc. The wait-staff typically takes and records the customer's orders on paper, after which orders are then walked to the kitchen or central services stand for input to the cooking staff. A well-developed restaurant communication systems should enable staff to connect finished meals with the customers who ordered them, and convey details about special requests and special needs. Restaurant management must also develop information systems for communicating with both the front and the back of the house about issues such as low stock on particular menu items or ingredients.

A system according to invention principles addresses the above problems and concerns.

### SUMMARY

It is an object of the present invention to provide a restaurant communication system including a first mobile device, a second mobile device, a server and a plurality of receiving devices. The first mobile device is located at a restaurant, is enabled for wireless communication and has a first display and an application. The server is positioned at a location remote to the restaurant and is wirelessly connectable to the first mobile device. The server includes a database having at least one menu with a plurality of dishes, each dish being associated with a dish image, a dish description and a location at the restaurant where this dish is prepared. The second mobile device is located at the restaurant. It is also enabled for wireless communication and includes a second display. Receiving devices are located within the restaurant at the locations where the dishes are prepared. The server is configured to exchange data with the first mobile device, the second mobile device and the receiving devices. The application of the first mobile device causes the menu to display at the first display and the dish image and the dish description for a dish selected by a user to appear at the first display at a user's request. Further, when the user selects an order option displayed on the first display, the application of the first mobile device causes an order request to be sent to the second mobile device and to at least one of said receiving devices via the server. The receiving device to which the order request is sent is located at the location at which the selected dish is to be prepared.

It is another object of the invention to provide a restaurant communication and management system, which includes a restaurant's Point-of-Sale (“POS”) system. The POS system includes a host-table administration component, a menu component, an inventory component and a payment component.

It is another object of the invention to provide a restaurant communication method in which a first mobile device is provided to a user in a restaurant, and the first mobile device is wirelessly connected to a server. The server is located remotely to the restaurant and includes a database storing at least one menu with a plurality of dishes, each dish being associated with a dish image, a dish description and a location at the restaurant where the dish is prepared. The server is also configured to wirelessly exchange data with the first mobile device. The method also includes causing the menu, the dish image and the dish description for a dish selected by a user to appear at a display of the first mobile device at a user's request and allowing the user to place an order by selecting at least one of the dishes displayed at the display of the first mobile device. The server then wirelessly connects to a second mobile device, located within the restaurant and carried by a restaurant staff person, and wirelessly transmits the order from the first mobile device to the second mobile device via the server. Further, the server wirelessly connects to a receiving device, located at a location within the restaurant where the dish selected by the user is prepared, and wirelessly transmits the order from the first mobile device to the receiving device.

The above objects, aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWING

The invention is illustrated by way of example and not limitation and the figures of the accompanying drawings in which like references denote like or corresponding parts, and in which:

FIG. 1 is a schematic diagram of the restaurant communication system in accordance with one preferred embodiment.

FIG. 2 is a schematic illustration of the first mobile device.

FIG. 3 is a schematic illustration of a database structure storing a restaurant menu.

FIG. 4 is a schematic illustration of options associated with a particular dish.

FIG. 5 is a schematic illustration of the second mobile device.

FIG. 6 is a schematic illustration of the opening reservation screen.

FIG. 7 is a partial schematic view of the information recorded in a reservation database.

FIG. 8 is a schematic diagram of the dataflow in the reservation component of the system.

FIG. 9 is a partial schematic view of the information recorded in an inventory database.

FIG. 10 is an example of a digital menu screen.

FIG. 11 is an example of a digital menu screen showing menu categories.

FIG. 12 is an example of an order summary screen.

FIG. 13 is an example of an individual dish screen.

FIG. 14 is a schematic diagram of a structure and dataflow in the POS system.

FIG. 15 is an example of a digital bar menu screen.

FIG. 16 is a schematic illustration of the host-table administration component of the POS system.

FIG. 17 is a schematic illustration of the menu component of the POS system.

FIG. 18 is a schematic illustration of the payment component of the POS system.

FIG. 19 is an example of a login screen of the second mobile device.

FIG. 20 is an example of a table selection screen of the second mobile device.

FIG. 21 is an example of a notification screen of the second mobile device.

FIG. 22 is an example of an order screen of the second mobile device.

FIG. 23 is a schematic diagram of a kiosk ordering system.

FIG. 24 is a schematic diagram of an embodiment of the mobile user application.

### DETAILED DESCRIPTION OF THE PREFERRED EMBODIMENTS AND THE DRAWINGS

As used in this disclosure, the word “cloud” refers to the delivery of computing and storage capacity as a service to a heterogeneous community of end-recipients. End users access cloud based applications through a web browser or a light weight desktop or a mobile application, while the business software and data are stored on servers at a remote location.

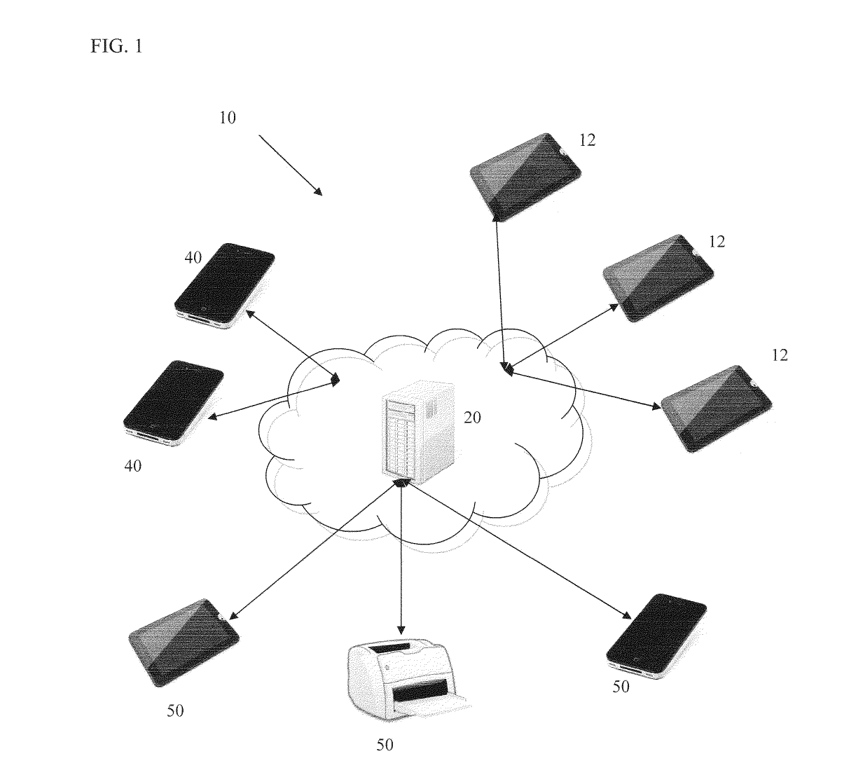

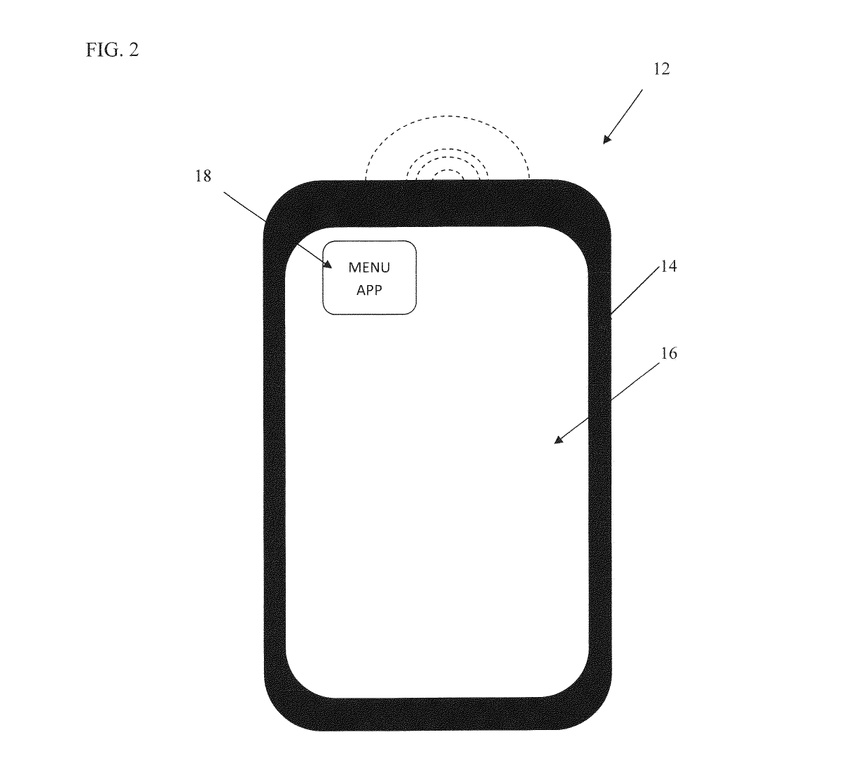

As shown in FIG. 1, in accordance with one preferred embodiment, a restaurant communication system 10 includes multiple first mobile devices 12 located at a restaurant. As shown in FIG. 2, each first mobile device is enabled for wireless communication and includes a body 14, a first display 16 and an application 18. Application 18 is a mobile application configured to access business software and data stored in a cloud. Tablets, smart phones or other wirelessly-enabled mobile devices can be utilized as first mobile devices 12. When customers sit down at a particular table in the restaurant, they receive the first mobile device 12 to make their selections and to place an order.

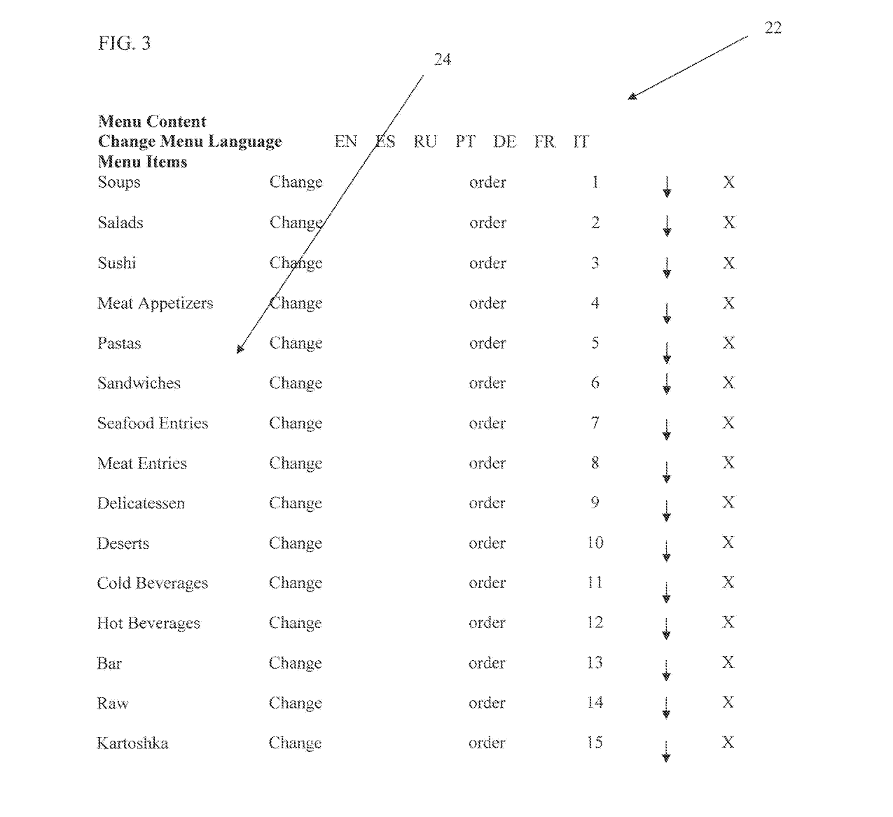

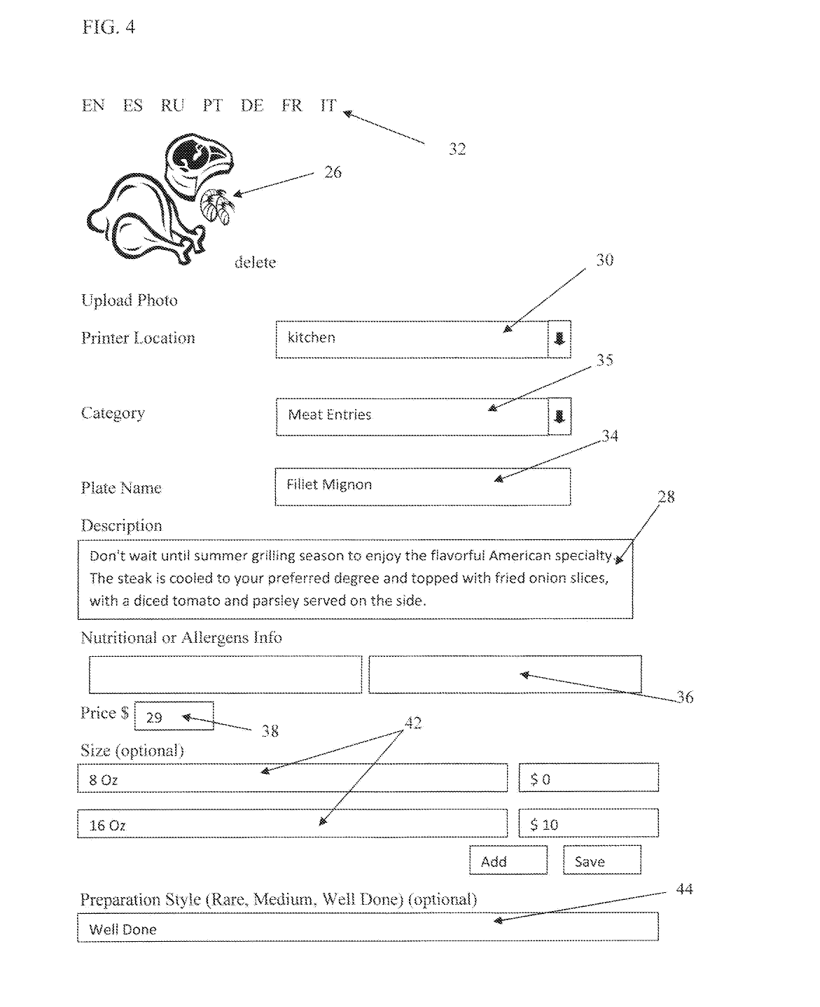

The restaurant communication system 10 further includes at least one server 20 positioned at a location remote to the restaurant. In one preferred embodiment, all data and all software necessary to enable various described functionalities of the disclosed systems are located in the cloud. Thus, the terms “server” and “cloud” are used interchangeably in this disclosure, and the term “server” is used herein to also mean multiple servers spread out among different locations. Server 20 is wirelessly connectable to the first mobile devices 12 and includes a menu database 22 (illustrated in FIG. 3) storing at least one menu 24. As shown in FIG. 4, menu 24 includes a plurality of dishes, each dish being associated with a dish name 34, a dish category 35, a dish image 26, a dish description 28 and a location 30 at the restaurant where this dish is typically prepared. For each dish, the menu also includes various language options 32, nutritional or allergens information 36, price 38, dish size parameter 42, and method of preparation parameter 44. Toppings and additional components of a dish can also be included. Although not shown, for each dish, the menu may also include a list of other dishes and a list of wines or other drinks recommended with the selected dish. Each dish description is accompanied by other additional facts relevant to the users, e.g., whether the dish is gluten-free. This information is stored in the menu database 22.

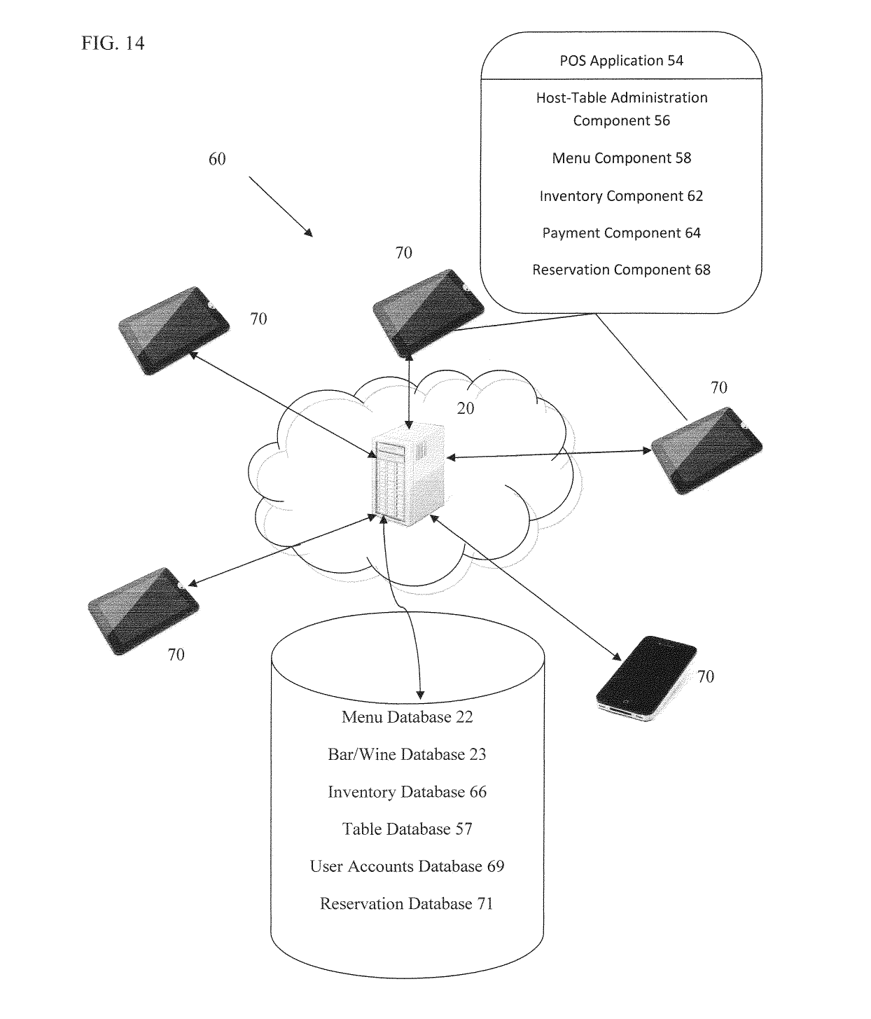

Digital menus 24 are preferably created by the restaurant's owner using a control panel at a remote website to which the owner has an access. The menu database and the control panel work as part of the remote server 20. In the web-accessible control panel the owner can choose among various patterns of the menu. In each pattern, the owner can change a background picture and add various design elements. Parameters of the others elements of design (pictures of buttons, dividing lines, colors and the sizes of fonts, etc.) will come from the server by means of web-service. There is preferably an additional database in which the design is stored. In addition to the menu database 22 and the design database, server 20 may include a number of additional databases, e.g., a wine/bar database, a customer account database, an inventory database, etc. Some of these databases are described in more detail below and shown in FIG. 14. Although these databases are described as being separate and distinct databases, it should be understood by a person skilled in the art that they can be implemented as one unitary database.

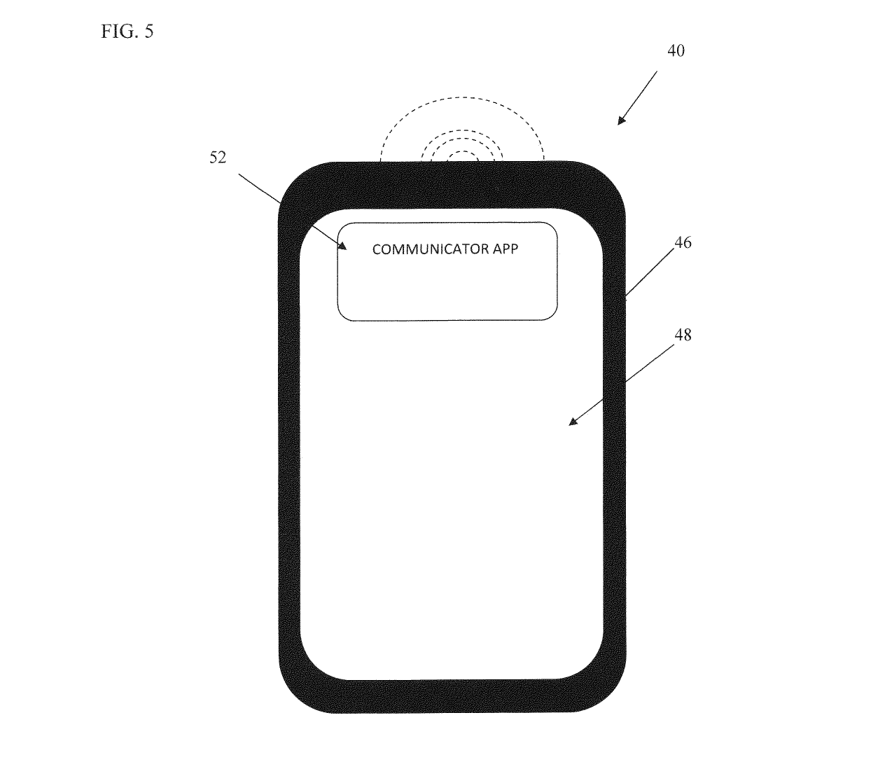

Additionally, restaurant communication system 10 includes a plurality of second mobile devices 40 located within the restaurant and utilized by the restaurant's personnel. As shown in FIG. 5, the second mobile device is enabled for wireless communication and includes a second body 46, a second display 48 and a communicator application 52. Similarly to application 18, communicator application 52 is a mobile application configured to access business software and data stored in a cloud. Tablets, smart phones or other wirelessly-enabled mobile devices can be utilized as second mobile devices 40.

Finally, restaurant communication system 10 includes a plurality of receiving devices 50 located at various restaurant's locations 30 where the dishes are prepared, each receiving device 50 being associated with one particular location 30. Receiving device 50 can be a printer, a mobile phone, a tablet or any other device enabled to receive communications from the server and output these communications in a readable form.

Within the communication system 10, server 20 is configured to exchange data with first mobile devices 12, second mobile devices 40 and the receiving devices 50. It should be understood that all described functionalities of all disclosed applications (e.g., application 18, application 52, etc.) are enabled by appropriate coding. In the preferred embodiment, the coding is implemented as a combination of iOS (a mobile operating system developed and distributed by Apple Inc.), Android (a Linux-based operating system for mobile devices), PHP (a general-purpose server-side scripting language) and SQL (a programming language designed for managing data in relational database management systems).

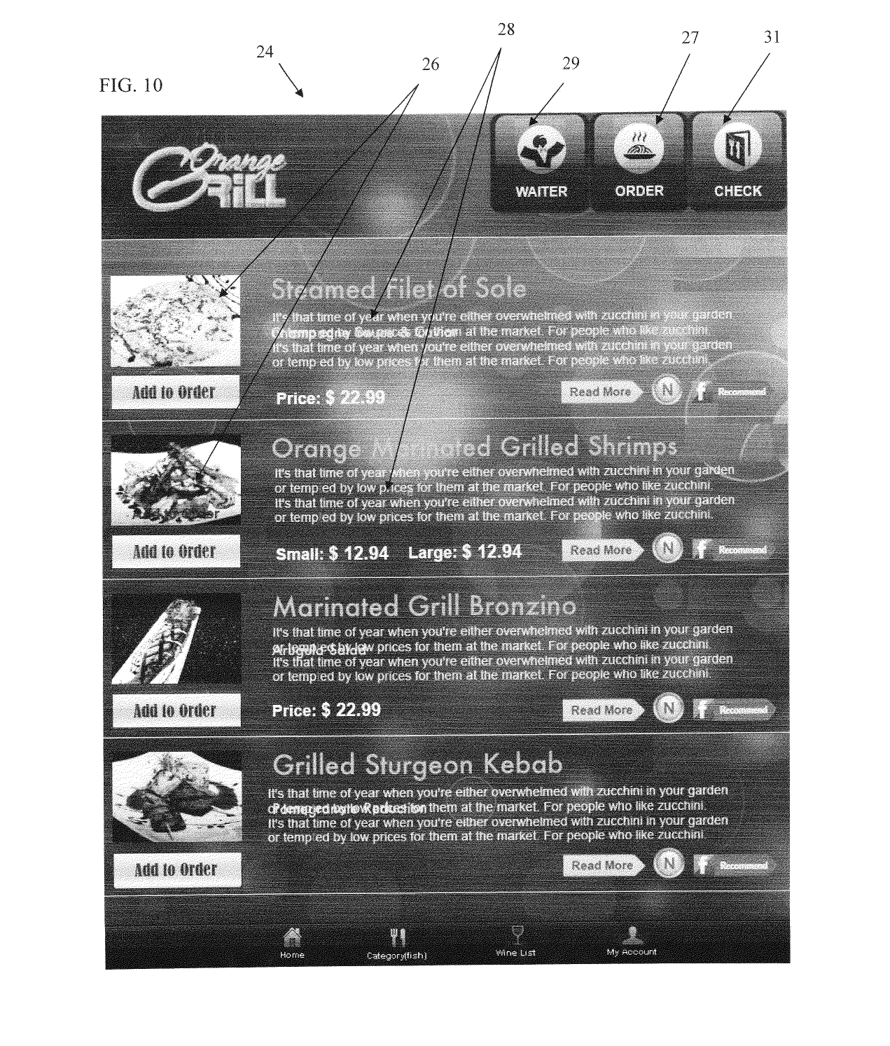

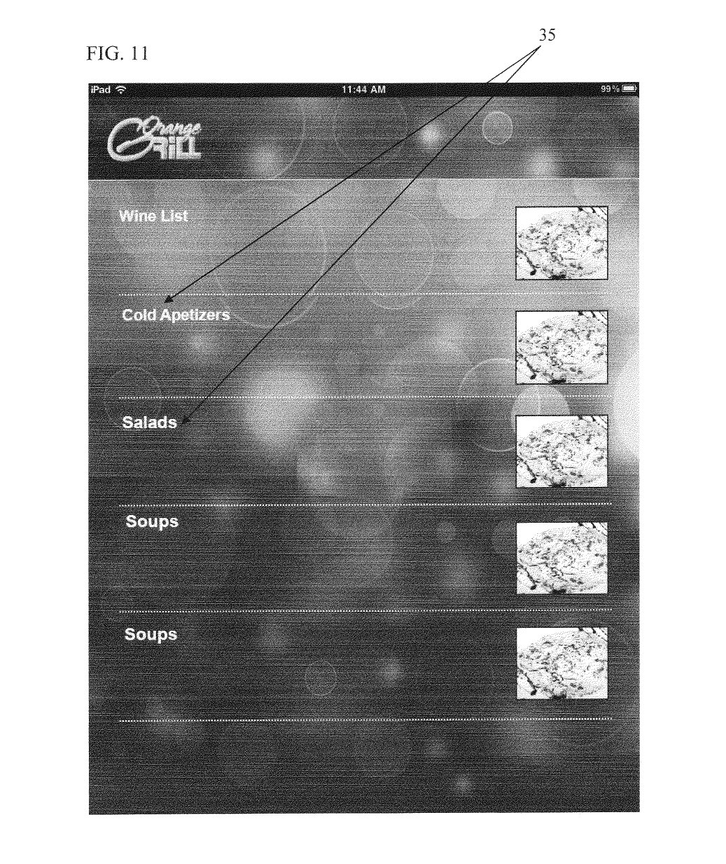

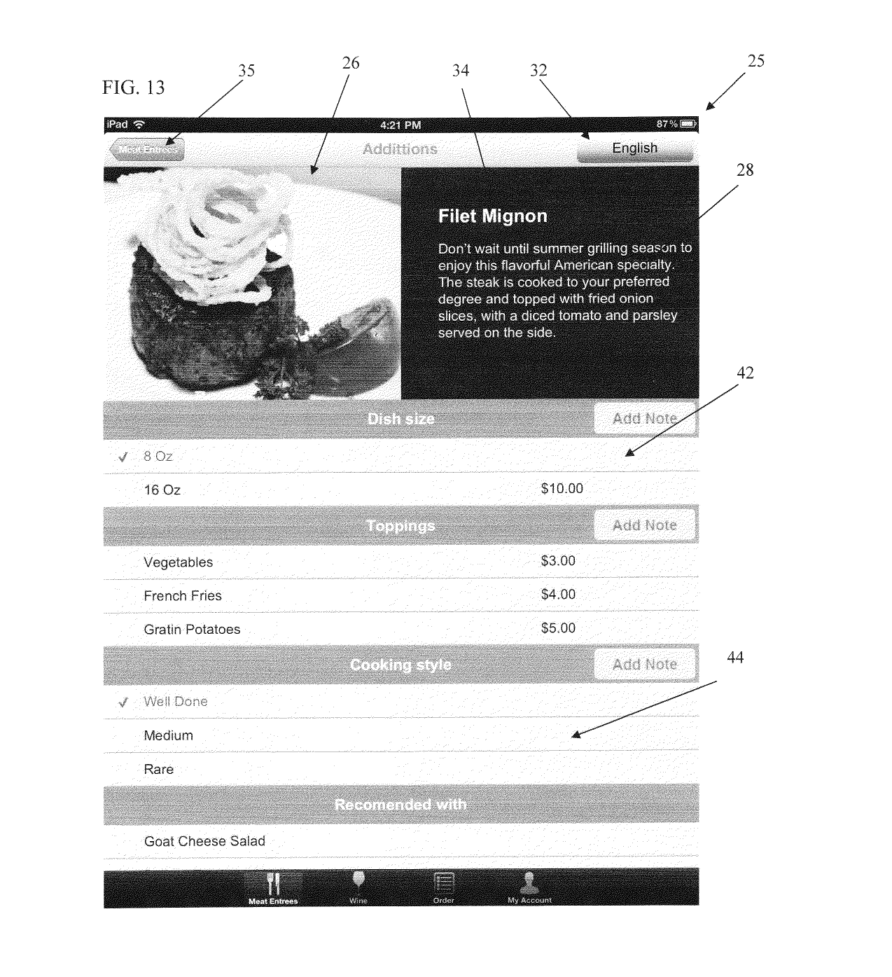

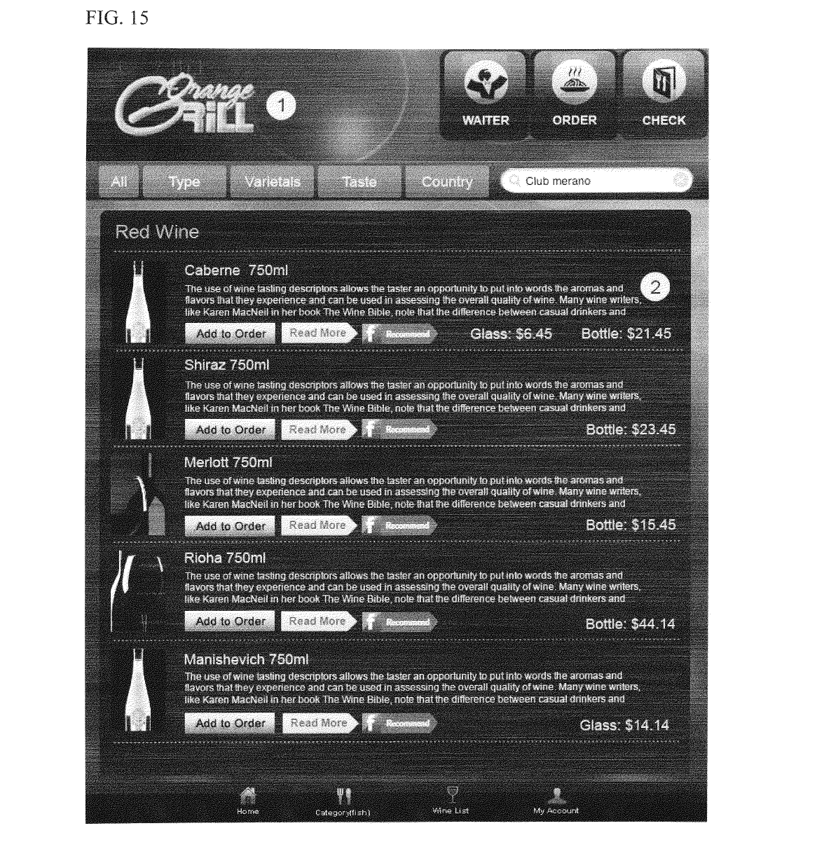

Operations of the application 18 of the first mobile device 12 will now be described with reference to FIGS. 10-13 and 15. When a restaurant customer sits down at a table and receives the first mobile device 12, application 18 causes menu 24 to display at the first display 16, as shown in FIGS. 10-11. As shown in FIG. 11, each menu is preferably divided into categories 35 (drinks, appetizers, salads, entries, wine list, etc.) which have been previously identified and stored by the owner in the menu database 22. Instead of appearing as a full screen (as shown in FIG. 11), the menu categories can be displayed as a pop-up menu on the screen. The customer selects a desired category 35 and views menu choices for the selected category. As shown in FIG. 10, for each category, names of the dishes 34, their descriptions 28 and their images 26 are preferably displayed at the first display 16. When customer selects an appropriate option, e.g., “read more” in FIG. 10, application 18 causes the dish image 26, the dish description 28 and other provided options for a particular dish selected by the customer to appear at the first display 16. After perusing the menu, the customer may add a particular dish to its order by selecting an “add to order” option. Application 18 then opens an individual dish screen 25 showing all individual modifiable parameters of the selected dish. As shown in FIG. 13, the individual dish screen 25 displays dish name 34, dish image 26 and dish description 28, and allows the customer to select the desired language 32, the desired dish size 42 and the method of preparation 44. Toppings and additional components of a dish are also displayed and can be changed per customer's request. Finally, “Recommended With” dishes are also displayed and can be added to anything on the menu. There is also an option for viewing a larger picture. If the option “Dishes recommended together with” is displayed and includes drinks, by clicking on the appropriate option, the customer will be directed to the bar menu 66, shown in FIG. 15. Information displayed in the bar menu is preferably stored in a bar/wine database 23 and is pulled from the wine/bar database by the application 18 to be displayed at the display 16. After the customer makes a selection, he/she is preferably returned back to the primary menu screen shown in FIG. 10 for more selections.

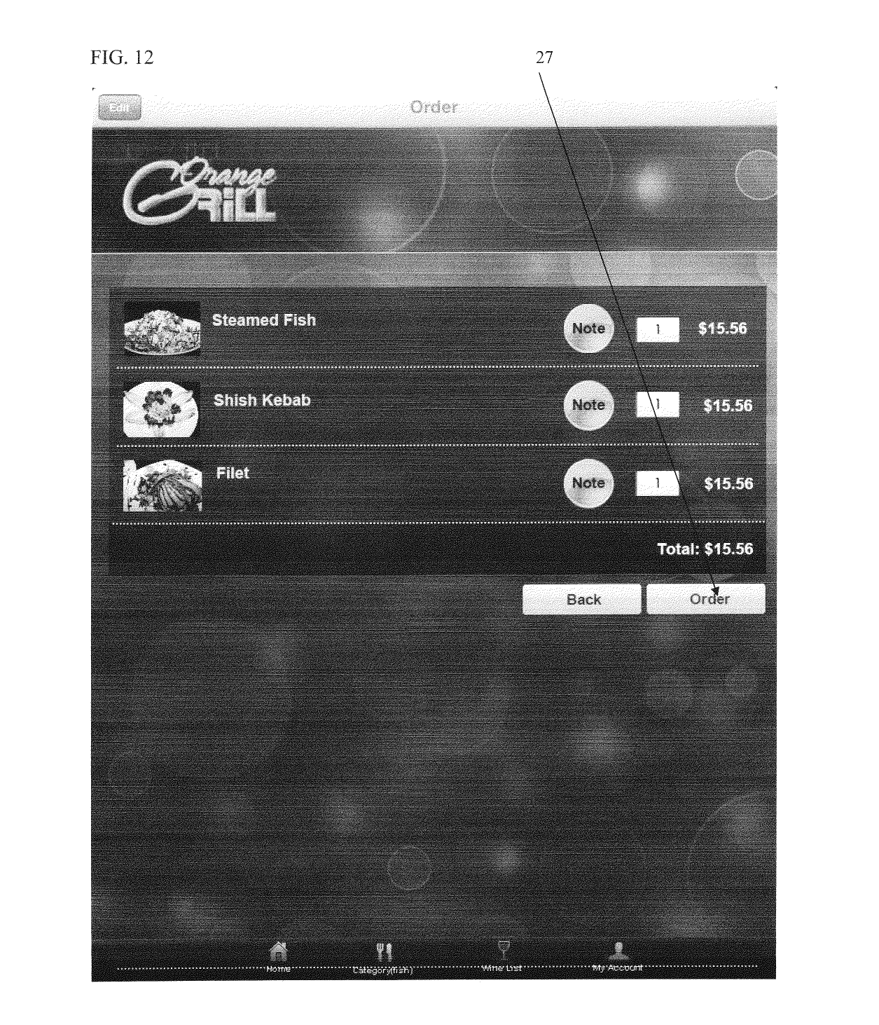

When the customer is ready to place the order, application 18 causes a list of all dishes selected by the customer to appear at the first display 16, as shown in FIG. 12. The customer can then add notes to the order, e.g., special preparation instructions, change quantity of a particular dish, and/or place the order. The order may be placed from the summary screen or from any other screen by selecting the “order” option 27. When the order is placed, application 18 of the first mobile device 12 causes the order request to be sent via the server 20 to a second mobile device 40 carried by a staff person assigned to the customer's table and to the receiving devices 50 located at particular locations 30 where the dishes selected by the customer are prepared. For example, if a customer orders a lobster roll and a glass of Sauvignon Blanc, the notification of this order is sent to the staff person's second mobile device 40, the order for the lobster roll is sent to the receiving device 50 located in the kitchen (or, for larger kitchens, to the receiving device located at a sandwich station), and the order for the wine is sent to the receiving device 50 located at the bar.

In addition to the order placing functionality, application 18 also allows the customer to call the staff person assigned to the customer's table by selecting option 29 and to request a check by selecting option 31 on the first display 16. See, e.g., FIG. 10. When the “call waiter” 29 or “check” request 31 is placed, application 18 of the first mobile device 12 causes the request to be sent via the server 20 to the second mobile device 40 of the staff person assigned to the customer's table.

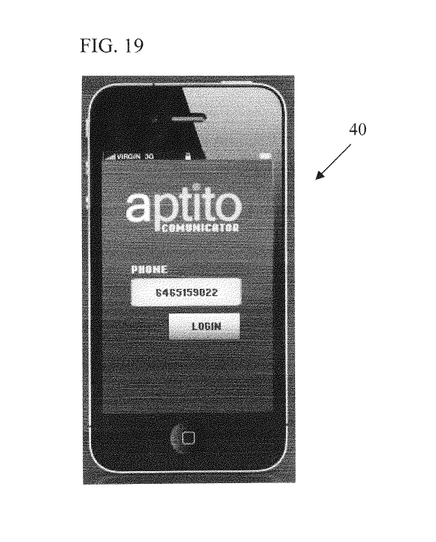

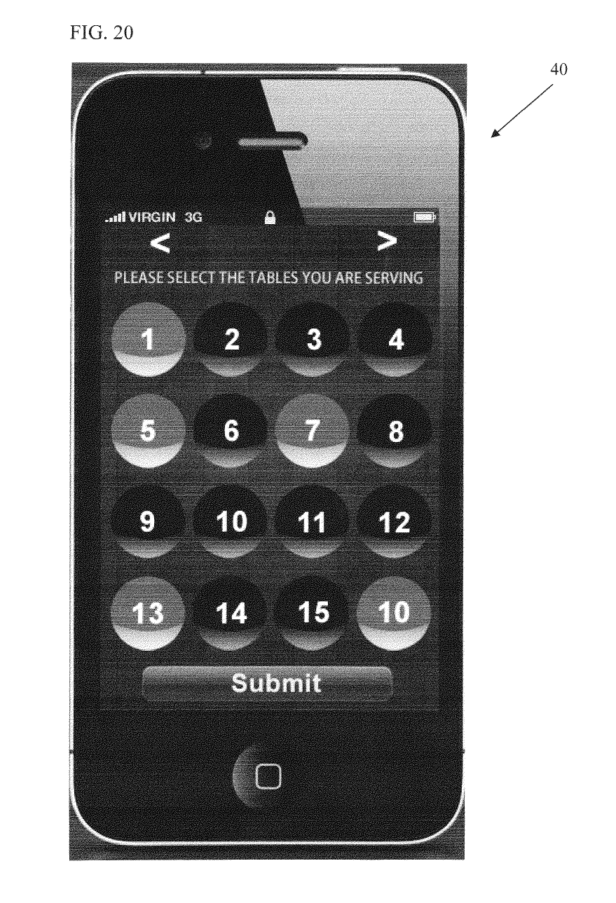

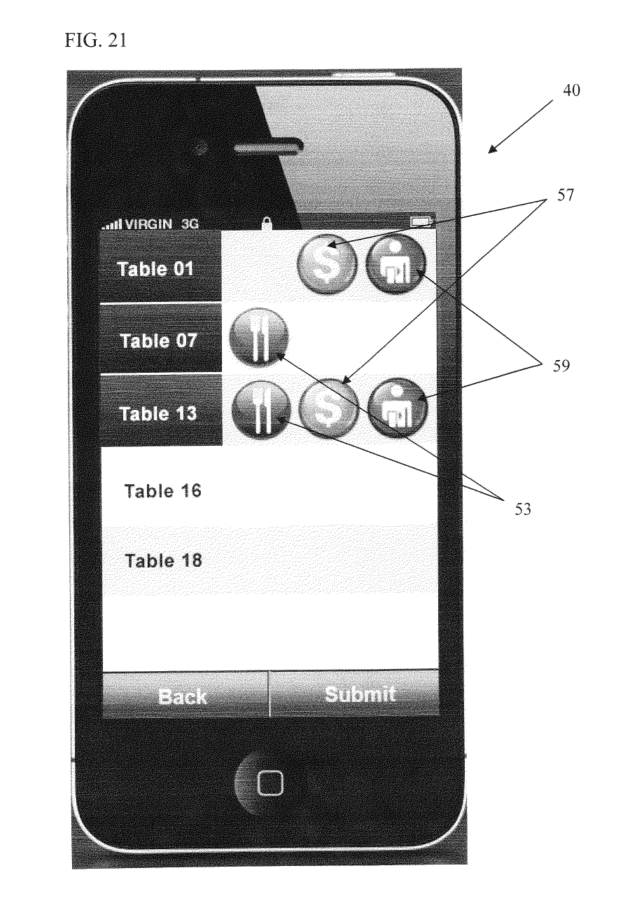

As indicated above, second mobile devices 40 include their own mobile application 52. Specific operations of the communicator application 52 are shown in FIGS. 19-22. Specifically, application 52 allows a particular staff person to sign in using his/her unique identifying information (see FIG. 19) and to select particular tables to which he/she is assigned (FIG. 20). After the tables are selected, communicator application 52 causes these selected tables to appear at the second display 48, as shown in FIG. 21. When a customer sitting at a table assigned to a particular staff person places an order using the first mobile device 12 located at this assigned table, the first application 18 causes the order to be conveyed to the second mobile device 40 (as described above), and the communicator application 52 causes an order notification 53 to appear at the second display 48. For example, as shown in FIG. 21, the notification may be represented by a circle with a fork and spoon appearing at the display in association with a corresponding table (i.e., tables 7 and 13 in FIG. 21).

Similarly, when the customer sitting at a table assigned to a particular staff person requests a check (using the option 31) or a waiter's attendance (using the option 29) on the first mobile device 12 located at this assigned table, the first application 18 causes the request to be conveyed to the second mobile device 40 (as described above), and the communicator application 52 then causes an appropriate notification (57 and 59, respectively) to appear at the second display 48 in association with the corresponding table. See, FIG. 21. Once the waiter fulfills the customer's request (or the customer pays the bill), these notifications can be cleared from the display by the staff person.

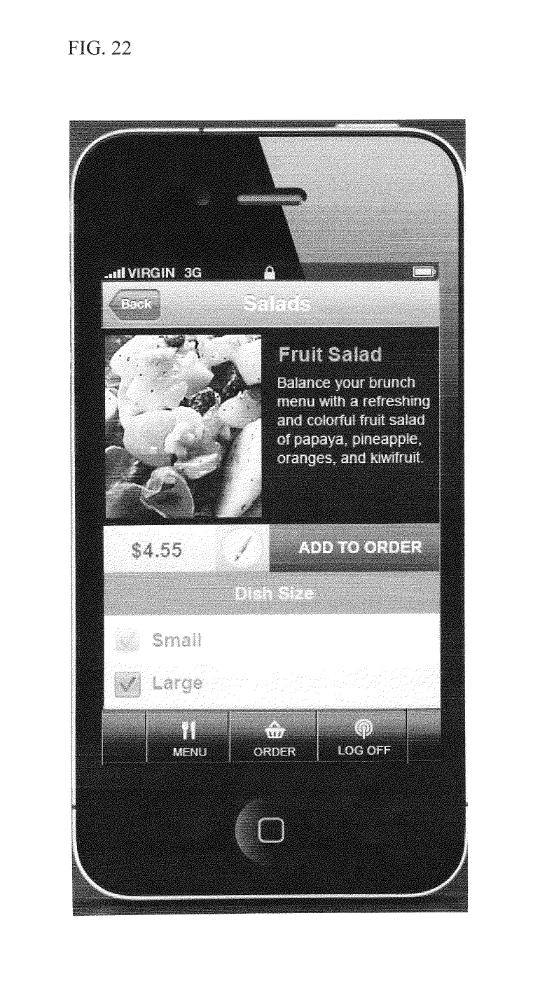

Some customers may have a difficulty in operating the first mobile device or may simply prefer to place an order the old fashioned way, i.e., by speaking to the waiter. For this purpose, communicator application 52 is also configured to receive customers' orders. Specifically, as shown in FIG. 22, at the request of the staff person, the communicator application causes digital menu 24 to appear at the second display 48. As the customer makes his/her selection, the staff person records the order by making desired selections from the menu in the same manner as described above with respect to the first mobile device. Once the order is reviewed an placed, application 52 of the second mobile device 40 causes the order request to be sent via the server 20 to the receiving devices 50 located at particular locations 30 where the dishes selected by the customer are prepared and also causes the notification 53 of the placed order to appear at the second display 42 in association with a particular table.

In addition to the options described above, in one preferred embodiment, application 18 of the first mobile device also includes an option for the customer to write a review of a particular dish and/or to recommend the dish and restaurant using social media. If this option is selected, application 18 allows the customer to create a review and then connects to a social media outlet allowing the customer to post the review. Alternatively, the reviews can be collected by the restaurant for its internal use only.

As described above, there is a multi-lingual capability in the menu application. However, it is preferred that static text elements remain in English. Names, descriptions of dishes, and their components can be translated to the language chosen by the user. All text/language elements are preferably stored in the menu database 22.

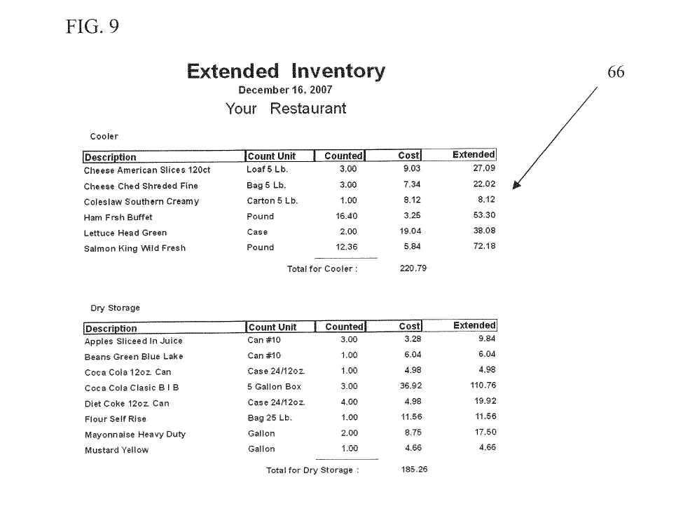

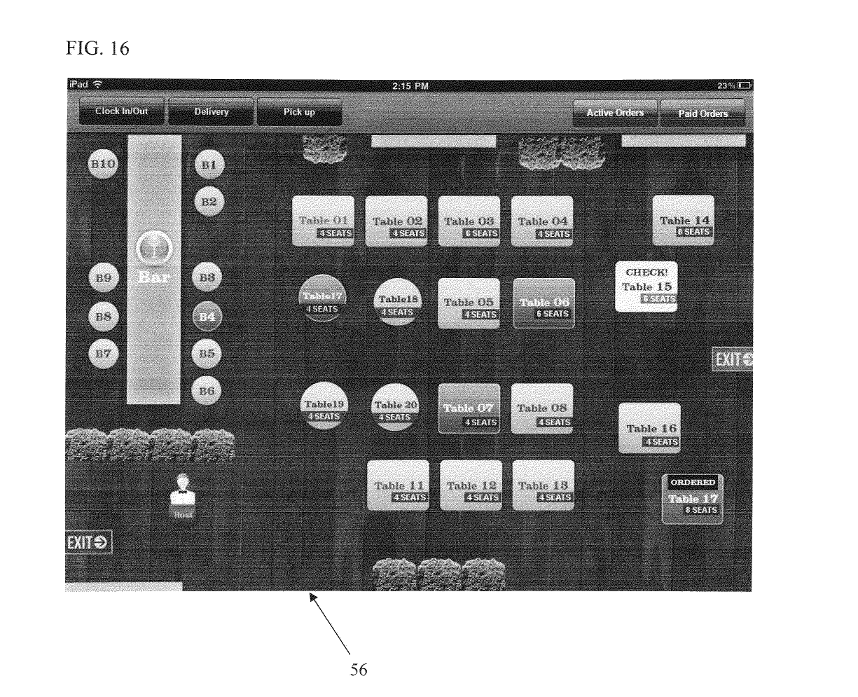

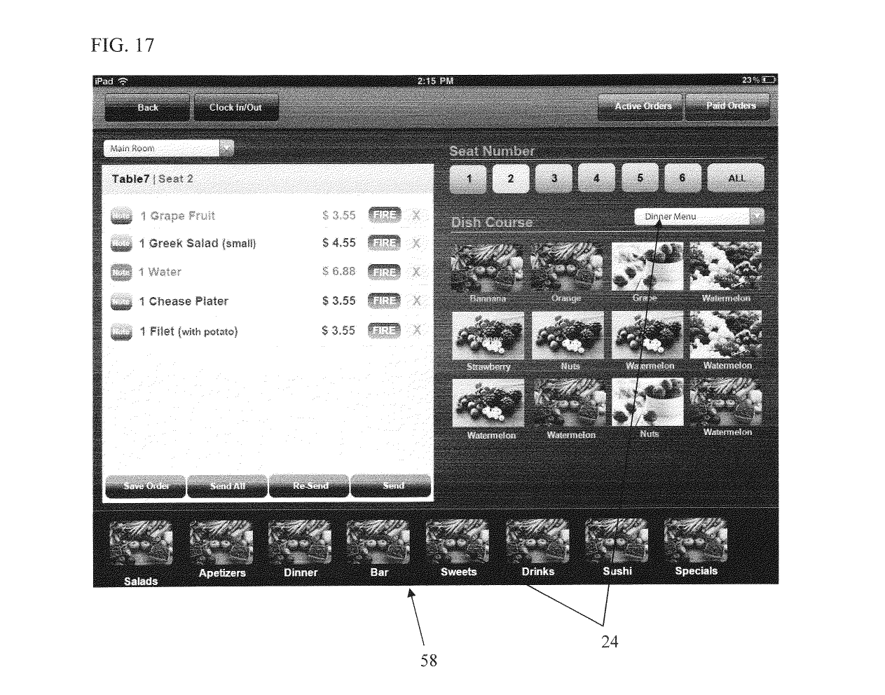

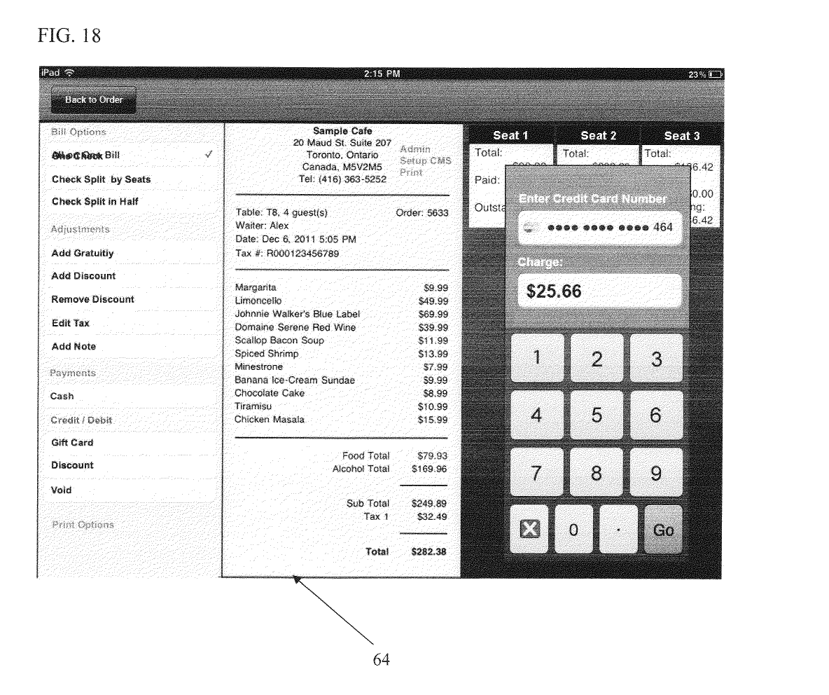

In another preferred embodiment, communication system 10 also includes a restaurant point-of-sale (“POS”) system 60. As shown, in FIGS. 14 and 16-18, the POS system 60 includes the cloud/server 20 and multiple POS mobile devices 70 with installed POS application 54. In its preferred embodiment, the POS application includes a host-table administration component 56 (shown in FIG. 16), a menu component 58 (shown in FIG. 17), an inventory component 62 (illustrated in FIG. 9) and a payment component 64 (shown in FIG. 18). It should be understood by a person skilled in the art that, while this specification describes POS mobile devices 70 as being different from the second mobile devices 40, both described functionalities can be implemented on the same mobile devices. Additionally, while various functionalities of the above components are described as being performed at POS mobile devices 70, it should be understood that the software and databases enabling these functionalities actually resides at the cloud/server 20. Thus, the term POS system, as used herein, includes both the functionalities performed at the POS mobile devices and the software and databases residing at the cloud/server.

FIG. 16 shows the host-table administration component 56. This feature is used by a host before seating guests down. Owner of the restaurant designs the restaurant layout preferably using web based templates and stores this layout at a table database 57 of the server 20. When customers arrive to the restaurant, host will select an open table and specify a number of guests. Adjacent tables can be combined, if a number of guests exceeds the maximum capacity of a single table. Then, while walking customers to the selected table, host will take at least one first mobile device 12 and activate it by clicking on the same table that was selected in the POS host-table administration component 56. Thus, the first mobile device will now be associated with the specified table number and ready for use as described above.

FIG. 17 illustrates the menu component 58 of the POS application. This feature is in many respects similar to the communicator application 52, where it is configured to receive customers' oral orders. Thus, menu component 58, at the request of the staff person, causes the menu 24 to appear at the display of the POS mobile device. As the customer makes his/her selection, the staff person records the order by making desired selections from the menu. To increase efficiency and to further personalize the restaurant's service, in its preferred embodiment, the menu component 58 allows the staff person to assign each customer at the table a seat number and to associate each order with a particular seat number. Thus, when the order is fulfilled, all guesswork as to who ordered what at the table is eliminated. Once the order is reviewed and placed, menu component 58 causes the order request to be sent via the server 20 to the receiving devices 50 located at particular locations 30 where the dishes selected by the customers are prepared, causes the payment component to calculate the running balance for the table (as shown in FIG. 18) and also causes a notification of the placed order to appear in the host-table administration component in association with the particular table (as shown, e.g., in FIG. 16 with respect to table 17). After the initial order is placed, the staff person can login to the system again using the menu component 58 and change/modify the order per costumer's request. All changes to the order are immediately reflected in the running balance for the table.

When customers are done with their meal, the payment component 64 allows them to select their bill option and their payment method. The final bill can be presented to the customers in its entirety, can be split by the seats in accordance with the dishes ordered by each person (associated with a particular seat), split equally among the customers or divided in any other way desired by the customers. Customers can pay the bill in cash, use their credit cards or use their account set up at the server 20 and stored in the user accounts database, as discussed in more detail below. A card-reader (not shown) can be secured to the POS mobile device 70 to enable this mobile device to read information from a customer's credit card and to automatically generate a credit card bill. The customer preferably signs the receipt electronically.

In this preferred embodiment, the POS system 60 also includes an inventory component 62. To implement the inventory component 62, the restaurant owner first creates an inventory database 66 (illustrated in FIG. 9), which lists all ingredients used in the restaurant's dishes, their prices and their vendors. Each dish from the menu database 22 is associated with its ingredients in the inventory database 66. Further, for each dish (and for each size of the dish, if the dish has multiple sizes), the exact quantity of each ingredient is specified. Once an item is created, it is stored in the data base until deleted.

When a customer places an order for a particular dish, the number of the available inventory for this dish's ingredients is automatically reduced by the above-designated quantity. The owner can set an alert level for inventory that is running low. For example, if a particular inventory is running low, it will be marked in red and the owner will receive a notification. Owner can than select the marked items and place a new order with a particular vendor.

In addition to the above-described components, the POS system also may include a reservation component 68, the dataflow in which is illustrated in FIG. 8. It is preferred (however, not necessary) that a user sets up an account at the server 20 prior to using the reservation component. In the preferred embodiment, the user will log in to a website associated with the disclosed system and set up an account by entering his/her name, address, food preferences, credit card information, and social networking preferences. This information is stored in the user accounts database 69 at the cloud 20. Database 69 also records user's activities at participating restaurants. Depending on the user's participation with the disclosed system, the user may be offered rewards from time to time.

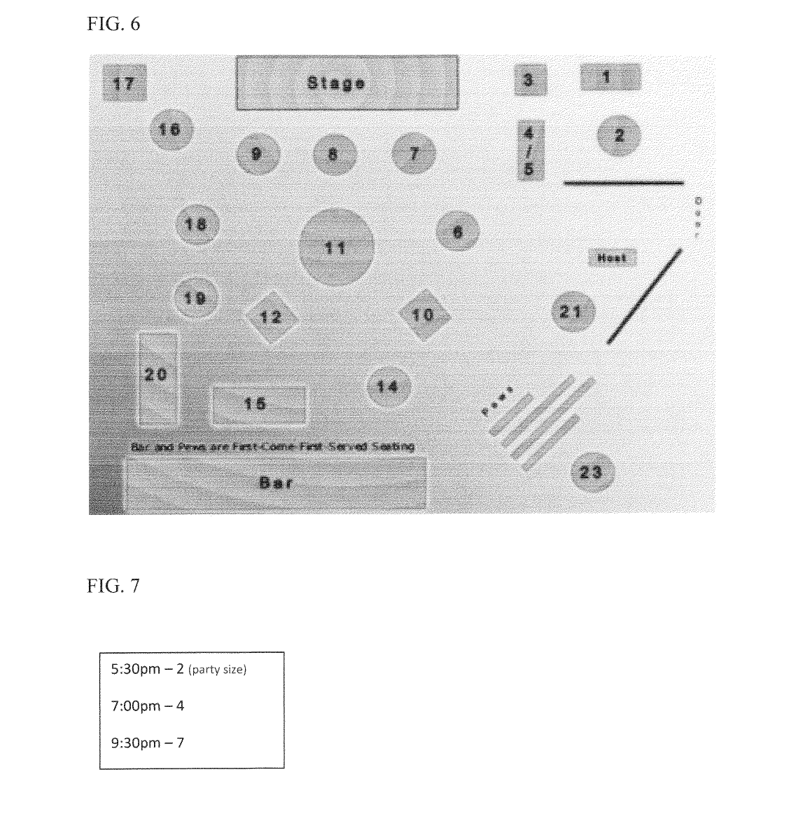

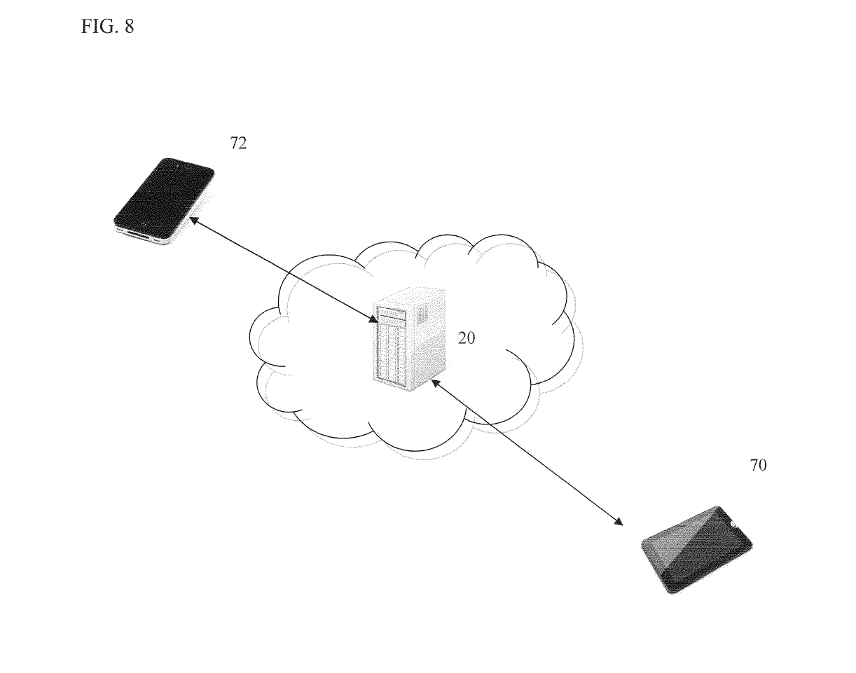

In the preferred embodiment, a customer will make a reservation by using a reservation application on his/her personal mobile device 72. The reservation application is connected through the server 20 to the restaurant's reservation component 68 of the POS system 60. The reservation application will then cause a restaurant table layout (shown in FIG. 6) to be displayed at the display of the personal mobile device 72 allowing the customer to make a selection. To make a reservation, the customer selects a table, enters the desired time and the desired number of guests. The reservation application conveys this information to the reservation database 71 (partially schematically shown in FIG. 7), which is updated. The POS system then updates the host-table administration component by showing the table selected by the customer as reserved (see e.g., tables 6 and 7 in FIG. 16) for the time slot selected by the customer. Of course, instead of a mobile device, the customer may use a personal computer to make the reservation from home. Alternatively, reservations can be made by the customer by calling the restaurant. The restaurant host will then manually input the reservation by choosing an open table in the host-table administration component, choosing an available time slot and inputting a number of guests. The host-table administration then updates its screen and the reservation database 71 to show the new reservation.

Prior to arriving at the restaurant, customers with the pending reservations will receive a notification from the reservation component of the POS system that their table is available. If the table is not available, the reservation component of the POS system will let the customer know and will notify him/her as soon as their selected table (or another table, which can accommodate the same number of guests) becomes available.

Once the customers arrive at the restaurant the host checks them in to their reserved table, and provides them with the first mobile device 12 for placing their orders, as described above.

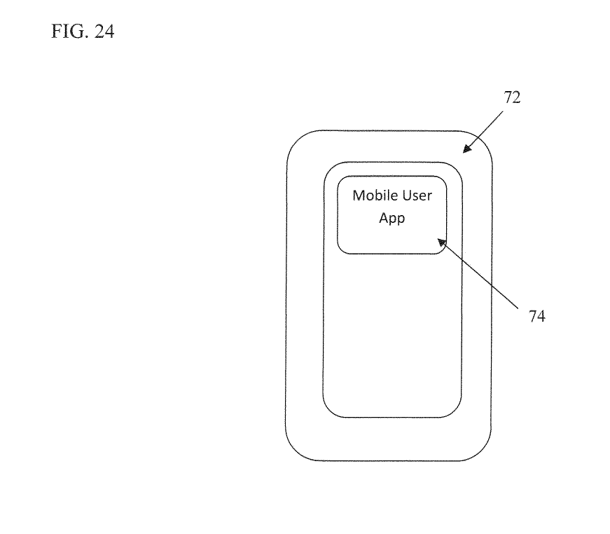

In another embodiment, the reservation application installed on the customer's personal mobile device 72 is a part of a broader mobile user application 74, as shown in FIG. 24. Mobile user application 74 includes a searching functionality allowing its user to search for a restaurant within a specified distance. Restaurants can also be searched by a cuisine or a name of a particular dish. Search results are displayed at the display of the personal mobile device 72. To perform the search function, mobile user application 74 receives the information from the personal mobile device's GPS (or another similar locating technology) to identify customer's current position.

After seeing the search results, the customer can choose one of the displayed restaurants. An option for checking in to the selected restaurant will be displayed. After physically arriving to the restaurant, the customer will accept the check in option, sit down at a particular table and select his/her table number at the display of the personal mobile device, which will display the restaurant layout. Mobile user application 74 then conveys this information into the restaurant's POS system, which, in turn, notifies a staff person assigned to this particular table and carrying a POS mobile device 70 or a second mobile device 40. To eliminate pranks, the POS system will allow the staff person to decline the notification if he/she determines that nobody is sitting at the indicated table. Once the staff person confirms that the customer indeed is at the designated table, he/she will send a confirmation to the POS system, which will forward a digital menu to the customer's personal mobile device 72. The customer may then use the personal mobile device 72, in the same manner as described above with respect to the first mobile device 12, to place an order. Thus, the users are able to view the menu, request waiter, place an order, request a check and make payments directly from their mobile phones.

In addition to the above functionalities, mobile user application 74 includes an option for the user to invite his/her friends to the same restaurant, reserve a table for him/herself and/or the friends, allow other people to see where the user is dining at a particular time, order food delivery, search for other friends and/or recommend the restaurant to others.

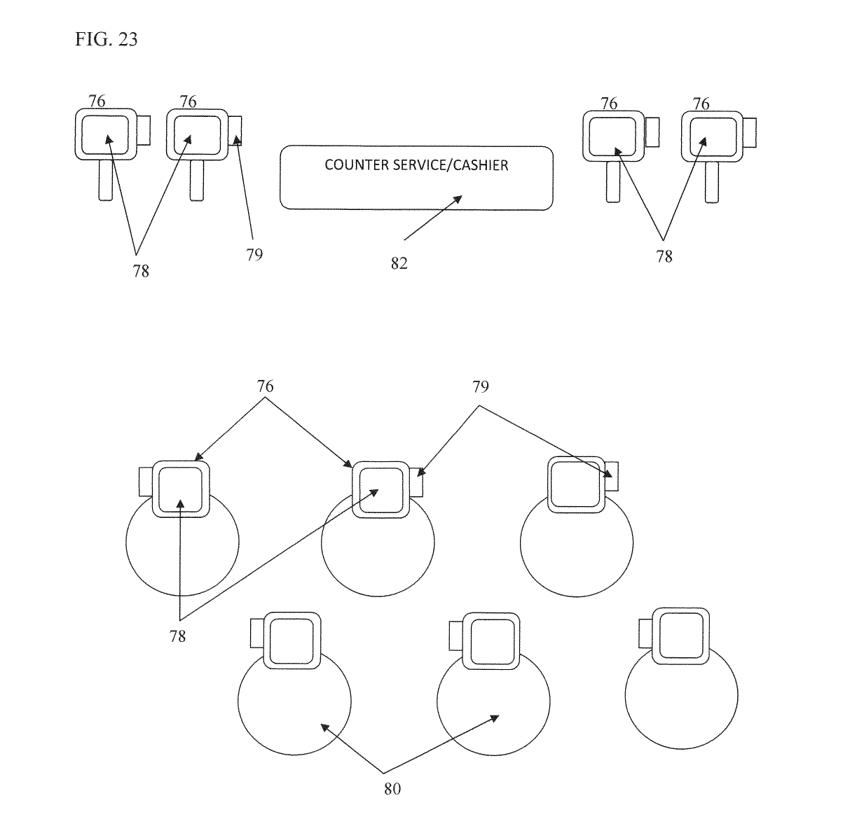

Another alternative embodiment of the present invention is illustrated in FIG. 23. This embodiment relates to a kiosk system of restaurant management. As shown in FIG. 23, in a participating restaurant, there is a counter service 82 and/or a plurality of sit down tables 80. Each counter service is accompanied by a plurality of wireless ordering stations 76 fixedly secured within the restaurant. Each wireless ordering station 76 includes a display 78 and a card reader 79. Wireless ordering stations 76 operate in the same manner as the first mobile devices 12 described above. Thus, they include an application allowing the customer to see a digital menu, make a selection, place an order and pay for the order using a user account or a credit card (by swiping the card through the card reader 79). Once the customer places the order, it is sent through the cloud/server 20 to the appropriate receiving device 50 for fulfillment and is then delivered to the customer waiting at the counter 82. A customer can also choose to pay cash for his/her order at the counter 82. In this case, the order is not sent to the appropriate receiving device until the cash payment is processed. Alternatively, if the restaurant includes the sit down tables 80, at least one wireless ordering station 76 is fixedly secured to the table. Similarly to the above, once the customer places an order and pays for it using his/her account or a credit card, the order is forwarded through the cloud/server 20 to the appropriate receiving device 50 for fulfillment and is then delivered to the customer's table. Similarly to the counter service, the customer may choose to pay cash by requesting a staff person to come over to his/her table and taking the money.

While there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention.

1. A restaurant communication system comprising:
a first mobile device enabled for wireless communications and having a first display and an application;
a server positioned at a location remote to the restaurant and wirelessly connectable to the first mobile device, the server comprising a database including at least one menu having a plurality of dishes, each dish being associated with a dish image, a dish description and a location at the restaurant where said dish is prepared;
a second mobile device located at the restaurant and carried by a restaurant staff person, the second mobile device being enabled for wireless communications and having a second display; and
a plurality of receiving devices located at said locations at the restaurant where said dishes are prepared,
wherein the server is configured to exchange data with the first mobile device, the second mobile device and the receiving devices,
wherein the application of the first mobile device causes the at least one menu to display at the first display,
wherein the application of the first mobile device is a mobile application which is configured to remotely search for a restaurant, to remotely connect the first mobile device to the server, to make reservations at the restaurant and, when a user of the first mobile device is physically located at the restaurant, to cause the dish image and the dish description for a dish selected by the user to appear at the first display at a user's request, and
wherein, when the user places an order for the selected dish by selecting an order option displayed on the first display, the application of the first mobile device further causes a notification of the order to be sent to the second mobile device via the server and causes the order for the selected dish to be sent to a receiving device located in a location in which the selected dish is prepared via the server.

2. The restaurant communication system according to claim 1, wherein the second mobile device comprises a second application, and wherein, when said notification of said order is received by the second mobile device, the second application causes said notification to appear at the second display.

3. The restaurant communication system according to claim 1, wherein the second mobile device comprises a second application, and wherein said second application displays a plurality of restaurant tables at said second display and allows the restaurant's staff person to choose particular tables out of said plurality of tables for which the staff person is responsible.

4. The restaurant communication system according to claim 1, wherein the second mobile device comprises a second application, and wherein said second application causes the at least one menu to display at the second display.

5. The restaurant communication system according to claim 1, wherein said application of the first mobile device further comprises a check request option displayed at the first display, and wherein, when the user selects the check request option, the application of the first mobile device causes a notification of a check request to be sent to the second mobile device via the server.

6. The restaurant communication system according to claim 5, wherein the second mobile device comprises a second application, and wherein, when said notification of said check request is received by the second mobile device, the second application causes said notification of said check request to appear at the second display.

8. The restaurant communication system according to claim 1, further comprising a POS system.

9. The restaurant communication system according to claim 8, wherein the POS system comprises a table database located at the server and storing a table layout of the restaurant, wherein the POS system further comprises a host-table administration application located at the second mobile device, wherein the host-table administration application is wirelessly communicable with the table database, wherein the host-table administration application causes the table layout to display at the second display, and wherein the host-table administration application allows the staff person to assign a particular status to a selected table at said table layout.

10. The restaurant communication system according to claim 8, wherein the POS system comprises a menu application located at the second mobile device, the menu application causing said at least menu to display at the second display and allowing said staff person to make order selections for the user.

11. The restaurant communication system according to claim 8, wherein the POS system comprises an inventory application and an inventory database located at the server and storing an inventory of the restaurant, wherein each dish of said digital menu is associated with at least one item of said inventory of the restaurant, and wherein when said user places the order for the selected dish the inventory application of the POS system reduces an amount of the at least one item associated with the selected dish in said inventory database.

12. The restaurant communication system according to claim 8, wherein the POS system comprises a payment application located at the second mobile device, wherein the payment application causes a bill for the user's order to display at the second display, and wherein the payment application allows the staff person to enter user's payment information directly into the POS system using the second mobile device.

13. The restaurant communication system according to claim 8, wherein the POS system comprises a reservations database located at the server and storing reservations for the restaurant, wherein the POS system further comprises a reservation application communicable with the reservations database, wherein the reservation application causes for time slots and tables available for reservations to display at a user's personal mobile device, wherein the reservation application allows the user to make a particular reservation, and wherein, when the particular reservation is made, the reservation application makes a corresponding change in the reservations database.

14. A restaurant communication method comprising the steps of:
providing a first mobile device to a user, the first mobile device having a first mobile application;
using the first mobile application of the first mobile device to search for a restaurant using multiple criteria;
using the first mobile application of the first mobile device to make reservations at the selected restaurant;
using the first mobile application of the first mobile device to remotely and wirelessly connect the first mobile device to a server, the server being located remotely to the selected restaurant, the server comprising a database including at least one menu with a plurality of dishes, each dish being associated with a dish image, a dish description and a location at the restaurant where said dish is prepared, the server being configured to wirelessly exchange data with the first mobile device;
when a user is physically located at the selected restaurant, using the first mobile application of the first mobile device to cause the at least one menu, the dish image and the dish description for a dish selected by a user to appear at a display of the first mobile device at a user's request;
allowing the user to place an order by selecting at least one of said plurality of dishes displayed at the display of the first mobile device;
wirelessly connecting the server to a second mobile device located within the restaurant and carried by a restaurant staff person, and wirelessly transmitting a notification of the placed order from the first mobile device to the second mobile device via the server; and
wirelessly connecting the server to a receiving device located at a location within the restaurant where said dish selected by said user is prepared, and wirelessly transmitting the order from the first mobile device to the receiving device.

15. The restaurant communication method according to claim 14, further comprising the steps of receiving the notification of the placed order at the second mobile device; and displaying the notification at a second display of the second mobile device.

16. The restaurant communication method according to claim 14, further comprising the steps of displaying a plurality of restaurant tables at a second display of the second mobile device; and allowing a restaurant's staff person to choose particular tables out of said plurality of tables for which the staff person is responsible.

17. The restaurant communication method according to claim 14, further comprising the step of causing the at least one menu to display at a second display of the second mobile device.

18. The restaurant communication method according to claim 14, further comprising the steps of displaying a check request option at the first display; and, when the user selects the check request option, causing a notification of a check request to be sent to the second mobile device via the server.

19. The restaurant communication method according to claim 14, further comprising the steps of storing a table layout of the restaurant in a table database located at the server; wirelessly connecting the second mobile device to the table database; causing the table layout to display at a second display of the second mobile device, and allowing a staff person to assign a particular status to a selected table at said table layout.

20. The restaurant communication method according to claim 14, further comprising the steps of causing a bill for the user's order to display at a second display of the second mobile device, and entering a user's payment information directly into the second mobile device.
